(19) United States
(12) Patent Application Publication
(10) Pub. No.: US 2006/0017010 A1
(43) Pub. Date: Jan. 26, 2006

(54) Magnet for scanning ion beams

(75) Inventors: Bo H. Vanderberg, Gloucester, MA (US); Kevin W. Wenzel, Belmont, MA (US); Robert D. Rathmell, Murphy, TX (US); Joseph Ferrara, Georgetown, MA (US); David R. Sabo, Hollis, NH (US)

Correspondence Address: WATTS, HOFFMANN CO., L.P.A., Ste. 1750, 1100 Superior Ave., Cleveland, OH, 44114, US

(73) Assignee: Axcelis Technologies, Inc.

(21) Appl. No.: 10/896,821

(22) Filed: Jul. 22, 2004

(51) Int. Cl. G21G 5/00

(52) U.S. Cl. 250/492.1

(57) ABSTRACT

An ion beam implanter includes an ion beam source for generating an ion beam moving along a beam line and a vacuum or implantation chamber wherein a workpiece, such as a silicon wafer is positioned to intersect the ion beam for ion implantation of a surface of the workpiece by the ion beam. A scanning magnet is most preferably used to control a side to side scanning of the ion beam so that an entire implantation surface of the workpiece can be processed.

### FIELD OF THE INVENTION

The present invention concerns ion implanters and more particularly an ion implanter having a scanning magnet for use in performing serial implants of a workpiece.

### BACKGROUND ART

Axcelis Technologies, assignee of the present invention, designs and sells products for treatment of workpieces such as silicon wafers during integrated circuit fabrication. Ion implanters create an ion beam that modifies the physical properties of workpieces such as silicon wafers that are placed into the ion beam. This process can be used, for example, to dope the silicon from which the untreated wafer is made to change the properties of the semiconductor material. Controlled use of masking with resist materials prior to ion implantation as well as layering of different dopant patterns within the wafer produce an integrated circuit for use in one of a myriad of applications.

An ion implantation chamber of an ion beam implanter is maintained at reduced pressure. Subsequent to acceleration along a beam line, the ions in the beam enter the implantation chamber and strike the wafer. In order to position the wafer within the ion implantation chamber, they are moved by a robot into a load lock from a cassette or storage device that is located at high pressure.

One prior art patent relating to an ion implanter is U.S. Pat. No. 5,481,116 to Glavish et al. This patent concerns a magnetic system for uniformly scanning an ion beam. The system has a magnet structure having poles with associated scanning coils and respective pole faces that define a gap through which the ion beam passes. A magnetic field set up by the magnet structure controllably deflects ions that make up the beam.

### SUMMARY OF THE INVENTION

The present invention concerns an ion beam implanter for implanting a workpiece such as a semiconductor wafer. The ion beam implanter includes an ion beam source for generating an ion beam moving along a path of travel and that can be scanned back and forth away from a beam centerline. A workpiece support positions a wafer in an implantation chamber so that the ions that make up the beam strike the workpiece.

One embodiment of an ion beam implanter that utilizes the invention includes an ion beam source for generating an ion beam moving along a beam line and structure that defines an implantation chamber having an evacuated interior region wherein a workpiece is positioned to intersect the ion beam for ion implantation of an implantation surface of the workpiece by the ion beam. Upstream from the implantation chamber the implanter includes a scanning magnet including a core material comprising an amorphous metal material. An electronic conductor, typically magnet windings sets up a magnetic field for scanning the ions in the ion beam from side to side.

An important aspect of the invention is use of a metallic glass for use as core material for a scanning magnet. This material exhibits sufficient magnetic permeability with low core loss at high scanning frequency to permit scanning from side to side of the beam at relatively high frequencies. These high frequencies are advantageous because the implant uniformity is improved if the scanning frequency is increased. As the workpiece moves within the implantation chamber, the magnet causes the beam to scan back and forth in an orthogonal direction. A high wafer scan frequency means the workpiece has a chance to move only a small amount during a side to side scan of the beam and this “painting” of a band across the workpiece without appreciable wafer movement improves implant uniformity. Higher scan frequencies also permit higher implant throughput (number of wafers per hour) and therefore greater implanter productivity.

These and other features of the exemplary embodiment of the invention are described in detail in conjunction with the accompanying drawings.

### BRIEF DESCRIPTION OF THE DRAWINGS

FIG. 1 is a schematic plan view of an ion beam implanter of the present invention;

FIG. 2 is a perspective view showing both a bottom and a top half of a scanning magnet constructed in accordance with one exemplary embodiment of the invention;

FIG. 3 is a perspective view of a bottom half of a scanning magnet that is constructed in accordance with the present invention; and

FIG. 3A is a plan view of a mandrel and coiled ribbon used in constructing magnet core sections; and

FIG. 3B is a plan view of a magnet core section that has been cut from the mandrel of FIG. 3A.

### EXEMPLARY MODE FOR PRACTICING THE INVENTION

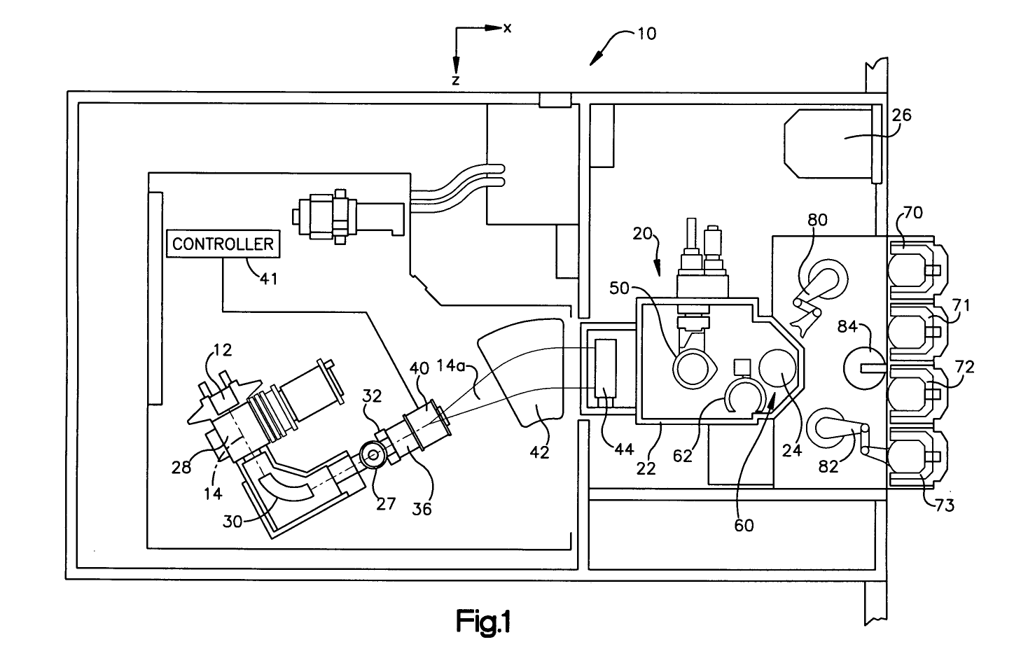

Turning to the drawings, FIG. 1 illustrates a schematic depiction of an ion beam implanter 10. The implanter includes an ion source 12 for creating ions that form an ion beam 14 which is shaped and selectively deflected to traverse a beam path to an end or implantation station 20. The implantation station includes a vacuum or implantation chamber 22 defining an interior region in which a workpiece 24 such as a semiconductor wafer is positioned for implantation by ions that make up the ion beam 14. Control electronics indicated schematically as a controller 41 are provided for monitoring and controlling the ion dosage received by the workpiece 24. Operator input to the control electronics are performed via a user control console 26 located near the end station 20. The ions in the ion beam 14 tend to diverge as the beam traverses a region between the source and the implantation chamber. To reduce this divergence, the region is maintained at low pressure by one or more vacuum pumps 27.

The ion source 12 includes a plasma chamber defining an interior region into which source materials are injected. The source materials may include an ionizable gas or vaporized source material. Ions generated within the plasma chamber are extracted from the chamber by ion beam extraction assembly 28 which includes a number of metallic electrodes for creating an ion accelerating electric field.

Positioned along the beam path 16 is an analyzing magnet 30 which bends the ion beam 14 and directs it through a beam shutter 32. Subsequent to the beam shutter 32, the beam 14 passes through a quadrupole lens system 36 that focuses the beam 14. The beam then passes through a deflection magnet 40 which is controlled by the controller 41. The controller 41 provides an alternating current signal to the conductive windings of the magnet 40 which in turn caused the ion beam 14 to repetitively deflect or scan from side to side at a frequency of several hundred Hertz. In one disclosed embodiment, scanning frequencies of from 200 to 300 Hertz are used. This deflection or side to side scanning generates a thin, fan shaped ribbon ion beam 14a.

Ions within the fan shaped ribbon beam follow diverging paths after they leave the magnet 40. The ions enter a parallelizing magnet 42 wherein the ions that make up the beam 14a are again bent by varying amounts so that they exit the parallelizing magnet 42 moving along generally parallel beam paths. The ions then enter an energy filter 44 that deflects the ions downward (y-direction in FIG. 1) due to their charge. This removes neutral particles that have entered the beam during the upstream beam shaping that takes place.

The ribbon ion beam 14a that exits the parallelizing magnet 42 is an ion beam with a cross-section essentially forming a very narrow rectangle that is, a beam that extends in one direction, e.g., has a vertical extent that is limited (e.g. approx ½ inch) and has an extent in the orthogonal direction that widens outwardly due to the scanning or deflecting caused to the magnet 40 to completely cover a diameter of a workpiece such as a silicon wafer.

Generally, the extent of the ribbon ion beam 14a is sufficient to, when scanned, implant an entire surface of the workpiece 24. Assume the workpiece 24 has a horizontal dimension of 300 mm. (or a diameter of 300 mm.). The magnet 40 will deflect the beam such that a horizontal extent of the ribbon ion beam 14a, upon striking the implantation surface of the workpiece 24 within the implantation chamber 22, will be at least 300 mm.

A workpiece support structure 50 both supports and moves the workpiece 24 (up and down in the y direction) with respect to the ribbon ion beam 14 during implantation such that an entire implantation surface of the workpiece 24 is uniformly implanted with ions. Since the implantation chamber interior region is evacuated, workpieces must enter and exit the chamber through a loadlock 60. A robotic arm 62 mounted within the implantation chamber 22 automatically moves wafer workpieces to and from the loadlock 60. A workpiece 24 is shown in a horizontal position within the load lock 60 in FIG. 1. The arm moves the workpiece 24 from the load lock 60 to the support 50 by rotating the workpiece through an arcuate path. Prior to implantation, the workpiece support structure 50 rotates the workpiece 24 to a vertical or near vertical position for implantation. If the workpiece 24 is vertical, that is, normal with respect to the ion beam 14, the implantation angle or angle of incidence between the ion beam and the normal to the workpiece surface is 0 degrees.

In a typical implantation operation, undoped workpieces (typically semiconductor wafers) are retrieved from one of a number of cassettes 70-73 by one of two robots 80, 82 which move a workpiece 24 to an orienter 84, where the workpiece 24 is rotated to a particular orientation. A robot arm retrieves the oriented workpiece 24 and moves it into the load lock 60. The load lock closes and is pumped down to a desired vacuum, and then opens into the implantation chamber 22. The robotic arm 62 grasps the workpiece 24, brings it within the implantation chamber 22 and places it on an electrostatic clamp or chuck of the workpiece support structure 50. The electrostatic clamp is energized to hold the workpiece 24 in place during implantation. Suitable electrostatic clamps are disclosed in U.S. Pat. No. 5,436,790, issued to Blake et al. on Jul. 25, 1995 and U.S. Pat. No. 5,444,597, issued to Blake et al. on Aug. 22, 1995, both of which are assigned to the assignee of the present invention. Both the '790 and '597 patents are incorporated herein in their respective entireties by reference.

After ion beam processing of the workpiece 24, the workpiece support structure 50 returns the workpiece 24 to a horizontal position and the electrostatic clamp is de-energized to release the workpiece. The arm 62 grasps the workpiece 24 after such ion beam treatment and moves it from the support 50 back into the load lock 60. In accordance with an alternate design the load lock has a top and a bottom region that are independently evacuated and pressurized and in this alternate embodiment a second robotic arm (not shown) at the implantation station 20 grasps the implanted workpiece 24 and moves it from the implantation chamber 22 back to the load lock 60. From the load lock 60, a robotic arm of one of the robots moves the implanted workpiece 24 back to one of the cassettes 70-73 and most typically to the cassette from which it was initially withdrawn.

Scanning Magnet 40

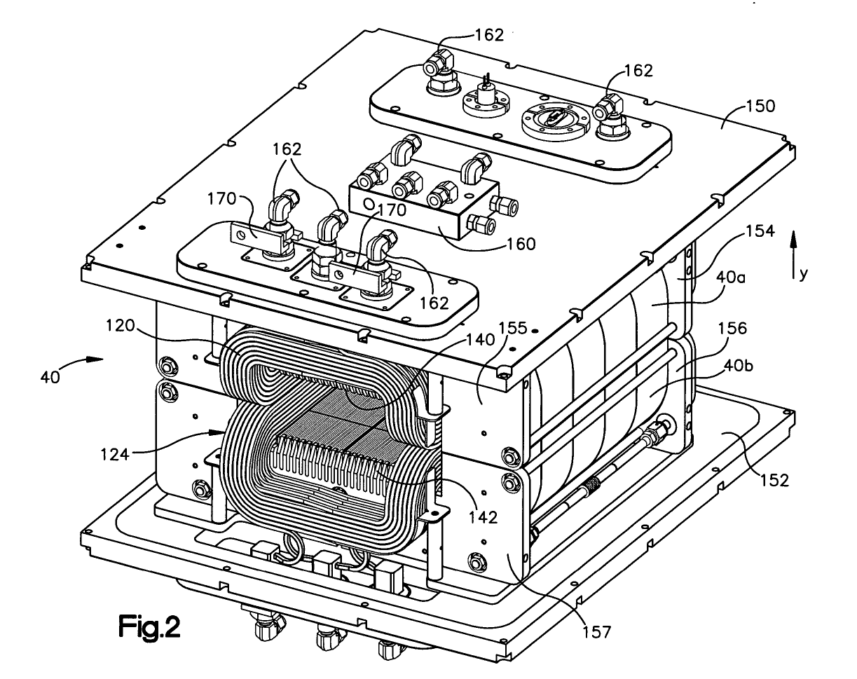

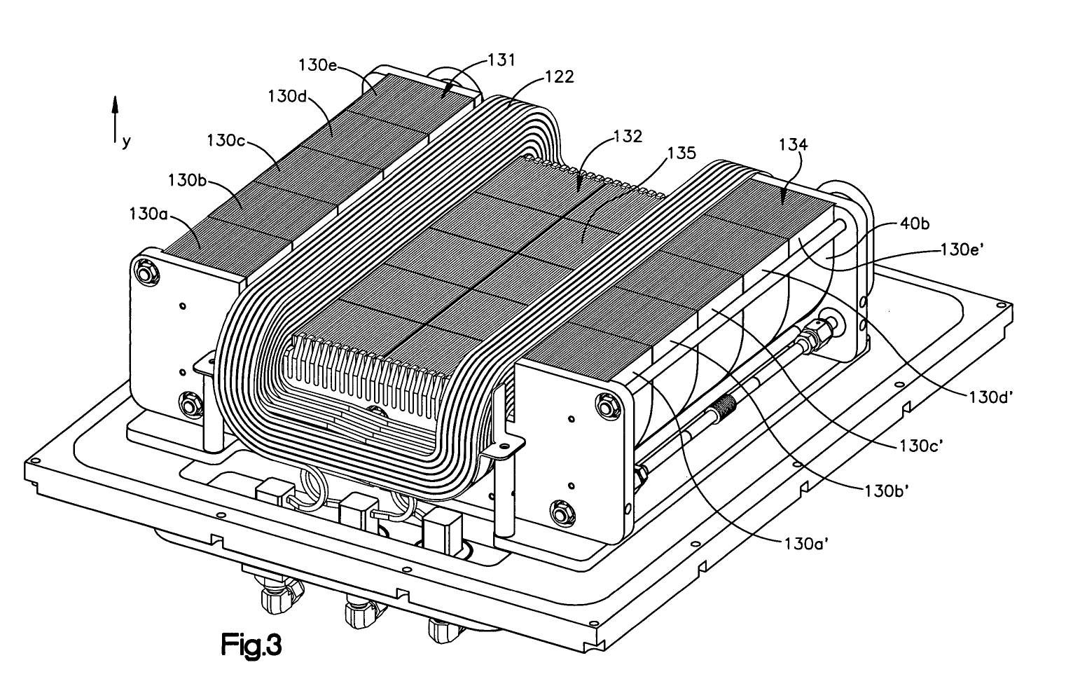

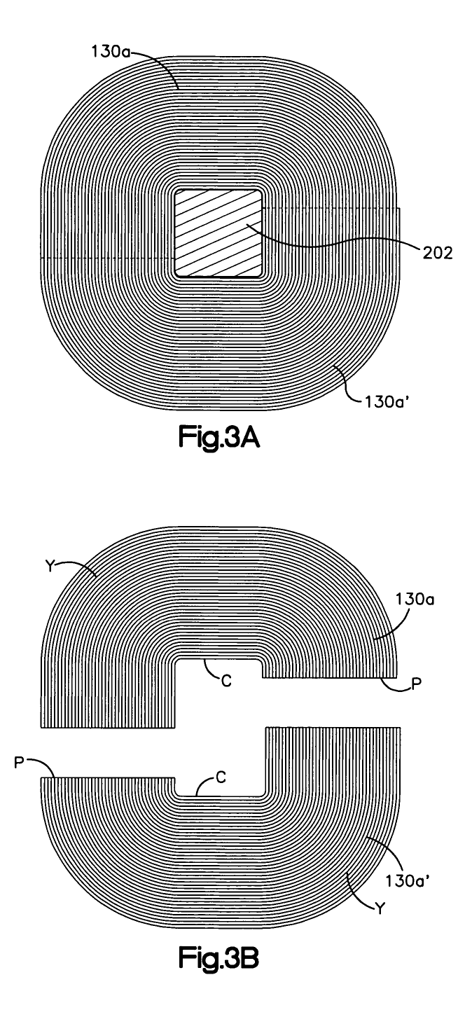

FIGS. 2 and 3 illustrate the structure of the scanning magnet 40 in greater detail. The magnet 40 is an electro magnet having a core, including yoke and pole pieces constructed from a ferromagnetic material. A magnetic field is induced in the pole gap of the magnet through controlled electrical energization of current carrying conductors 120, 122 (in this embodiment, the conductors are shaped to what is commonly referred to as saddle coils) that bound a region through which the ions of the beam 14 move. The current flowing in the coils induces a magnetic field with direction perpendicular to the path of the beam (the y-direction) to deflect a beam (traveling in the x-z plane) back and forth to form the beam 14a. The pole pieces help shaping the magnetic field in the pole gap to high uniformity, and the magnetic flux induced through the pole gap returns through the magnet yokes on either side of the pole gaps.

The conductors 120, 122 extend in a direction that parallels the direction of ion movement as ions enter the magnet 40. Portions of the conductors are positioned on either side of a centerline through the magnet 40. See FIG. 3 for the configuration of the coil 122. At an entrance to the magnet the conductors 120 extend upward and then across a front of the magnet to avoid contact with ions entering the magnet. Similarly, at an exit side of the magnet, the conductors 120 extend upward and then cross the ion beam line to avoid contact with ions that have been deflected as they leave the region of the magnet. The conductor 122 (FIG. 3) on the bottom half of the magnet similarly loops along the side of the beam path on opposite sides of the magnet and then extends across the front and rear by extending downwardly so that ions to not contact the conductor 122. The conductor 122 is a rigid assembly and is placed within the yoke of the magnet 40.

As seen in FIGS. 2 and 3, the magnet 40 includes upper and lower magnet portions 40a, 40b that are generally symmetric about a plane passing between the two portions (in the x-z plane). In combination with the conductors 120, 122, the two core portions 40a, 40b form an magnet entrance 124 so that ions leaving the quadrupole lens 36 enter a center passageway of the magnet. The core is made up of several sections and in the illustrated embodiment of FIG. 3, the magnet core can have ten sections 130a, 130a′, 130b, 130b′, 130c, 130c′, 130d, 130d′, 130e, 130e′. The core sections are constructed from five ribbon windings which are cut in two places to provide two sections of the magnet core. The windings are formed by spirally winding a ribbon of metallic glass onto a square shaped mandrel 202. After the spirally wound ribbon is removed from the mandrel, it is then cut in two places to form two separate sections of the core. For example, referring to FIG. 3A, a ribbon is wound around the mandrel 202 to form a a coiled ribbon of a desired thickness. The coiled ribbon is then cut in two places, represented by the dashed lines. Upon completion of the cuts, two core sections 130a, 130a′ are formed as shown in FIG. 3B. The two separate core pieces 130a, 130a′ are each generally “U” shaped having one prong of the “U” longer than the other.

The two formed sections 130a, 130a′ are arranged in the magnet with the longer prong of the “U” to the outer side of the magnet center passageway, as shown if FIG. 3. With respect to the magnet, ten core sections are situated having five core sections on each side (symmetric with respect to a magnet centerline) with the longer prong of each “U” shaped section to the outer side of the magnet. This configuration creates two channels C on each side of the center passageway. In the preferred embodiment, the conductors 120, 122 are situated in these channels. A yoke portion Y provides a return path for the magnetic flux that extends through the ion passageway between the bottom and top parts of the pole pieces P.

Each of the ten sections when in their respective location within the magnet form the overall core of the magnet. This core comprises two side segments 131, 134 and a center segment 132 having a surface 135 which bounds the beam passageway through the magnet. In one exemplary embodiment of the invention, a surface 135 of the core has a width between the two side segments 131, 134 (including the width of the channels C that accommodate the windings) of approximately ten (10) inches. The two side segments 131, 134 extend upwardly in the ‘y’ direction above the generally planar surface 135 of the center segment 132 and in one embodiment the distance from the plane 135 to an exposed face of the side segments 131, 134 is about three (3) inches.

Each of the core sections 130a-130e and 130a′-130e′ is made up of many individual magnet laminations which are thin generally planar sheets or ribbons that are wound about a mandrel 202 to form the magnet sections (130a for example). The exposed planar surface of the center segment 132 of the overall core is made up of a combination of the cut ends of the smaller prongs of each of the ten “U” shaped core sections. As shown in FIG. 3, five core sections comprise half of the overall core for each half of the magnet. The larger prong of the five “U” shaped sections resides on the outer side of the magnet or define the outer side of the center passageway. The combination of the longer prong of these sections define side segments 131, 134 which are exposed at core faces that abut corresponding faces on the other core half. The coils 120, 122 fit into a center passageway of the core sections 130a-130e and 130a′-130e′. When installed or mounted to the core, the coils are recessed within the core's center passageway in the channels C as described earlier and the exposed laminations on the core faces of the top and bottom core portions 40a, 40b are in contact with each other. Since each of the core sections (130a-130e and 130a′-130e′) is wound on a square shaped mandrel having rounded corners, a transition between the channel defining and prongs of the U shaped core sections have a rounded radius.

The laminations or sheets are constructed from an alloy of amorphous metal material, commonly referred to in the art as metallic glass. These amorphous metal alloys differ from conventional metals used, such as grain-oriented Silicon steel, in that they have a non-crystalline structure and possess unique physical and magnetic properties. Amorphous-metal alloys differ from their crystalline counterparts in that they consist of atoms arranged in near random configurations devoid of order. The amorphous metal alloy material is ferromagnetic, i.e., has a magnetic permeability much greater than 1. The amorphous metal alloy material is typically formed from metals comprising cobalt, iron, and nickel. More particularly one suitable amorphous metal material is chosen from an alloy of cobalt, iron, and nickel with the concentrations of the metals chosen to reduce the cost of producing the sheets while maintaining sufficiently high magnetic flux saturation density, i.e., greater than 1.5 Tesla. An important property of the metallic glass is that it exhibits low core loss at high frequency, typically more than ten times lower than the core loss of Silicon (transformer) steel. The low core loss reduces the power consumption of the scanning magnet 40 as well as cooling requirements and, therefore, operating temperature.

Several techniques for creating a ribbon for fabricating a core are known. One known construction technique is known as planar flow casting. In this variation of chill-block melt spinning, molten metal is forced through a slotted nozzle in close proximity (≈0.5 mm) to the surface of a moving substrate. A melt puddle is formed which is simultaneously contacting the nozzle and the substrate and is thereby constrained to form a stable, rectangular shape. While the flow of molten metal through the nozzle is controlled by pressure, it is also dependent on a gap or spacing between the nozzle and the substrate. Using planar flow casting, amorphous metal ribbon widths up to 300 mm have been realized, and widths up to 210 mm are commercially available. Once the ribbon or individual sheet is formed (such as the sheets used to fabricate the core sections 130a, 130b etc) it is wound about a supporting mandrel. A binder is included with the amorphous metal material and can be either a silicate or a glass. After winding the ribbon forms a coiled spiral that is held together with a suitable adhesive such as epoxy. One suitable amorphous metal alloy material for use in creating the core sheets is commercially available from Metglas having a place of business at Jimmy W. Jordan 440 Allied Drive, Conway, S.C. 29526 and sold under product designation 2605SA1. This product provides extremely low core loss (less than 0.2 W/kg at 60 Hz, 1.4 Tesla) or 30% of the core loss of grade M-2 electrical steel (core loss at 50 Hz is approximately 80% of 60 Hz values) and high permeability (maximum D.C. permeability (μ)-annealed-600,000; cast-45,000). A data sheet describing the properties of this product is commercially available from Metglas and is incorporated herein by reference. The details of amorphous metals and the process of creating a ribbon of material is disclosed in, “Amorphous Metals in Electric-Power Distribution Applications,” Nicholas DeCristofaro, MRS Bulletin, Volume 23, Number 5 (1988) P. 50-56, and is hereby incorporated by reference in its entirety.

The ions that make up the beam 114 that enters the magnet entrance 124 are shaped upstream by the quadrupole focusing structure. There are always ions, however, that will deviate from the normal path and some of these ions impact upon structure of the magnet 40. To avoid damage to the structure of the center portion 132 of the magnet the magnet includes top and bottom entrance shields 140,142 constructed from steel. The shields are constructed from planar steel laminations which are bound together by a suitable adhesive that reduces contamination in the region of the beam line.

The two halves of the magnet yoke (all ten core sections in the exemplary embodiment) are supported by structure above and below the beam line that includes mounting flanges 150, 152 that support the yoke and saddle coils. The saddle coils are constructed from hollow electrically conductive conduits through which a coolant such as water is routed during operation of the magnet. Prior to assembly, the conduits are electrically insulated with thin coatings of enamel or epoxy. The assembled saddle coil is held together by a vacuum compatible epoxy glue, typically cured in vacuum. Extending downwardly from the top flange 150 and upwardly from the bottom flange 152 are end plates 154, 155, 156, 157. These end plates are metal and define passageways through which suitable coolant such as water is also routed. As seen in FIG. 2, the flange 150 supports a manifold 160 for receiving cooling water and routing heated water away from the magnet. A similar manifold located on the bottom flange 152 performs these functions for the bottom half of the magnet. The manifold 160 delivers water through hoses (not shown) to couplings 162 at the front and rear of the magnet 40.

In operation control electronics coupled to bus bars 170 energize the saddle coils to create an alternating magnetic field that deflects the ions entering the magnet by a varying amount that depends on the instantaneous field strength when the ion enters the magnet. The B field has a vector component in generally the positive y direction with one polarity of coil energization and a vector component in generally the negative y direction with the second polarity electrical energization. This alternating field polarity in the positive and negative ‘y’ direction, as seen in the figures, produces a side to side beam scan in the x-z plane, since the larger the field magnitude, the greater the force on the ion, hence the smaller the bend radius of the ion inside the scanning magnet, since charged particles in magnetic fields follow circular trajectories, and therefore the greater the deflection. A triangular wave energization of the saddle coils produces a constant beam scan velocity transverse to the direction of travel of the unscanned beam. In the case of the scanning magnet, the scanning field or magnet current has to be accurately controlled to control the beam scan angle. In practice, the waveform is modulated to change scan speed and the time-averaged ion flux across the workpiece to obtain high dose uniformity of the implant.

While the present invention has been described with a degree of particularity, it is the intent that the invention includes all modifications and alterations from the disclosed design falling with the spirit or scope of the appended claims.

1. An ion beam implanter comprising:
a) an ion source for generating an ion beam confined to a beam path;
b) an implantation chamber having an evacuated interior region wherein a workpiece is positioned to intersect the ion beam; and
c) a scanning magnet positioned along the beam path between the ion source and the implantation chamber including i) a magnet core comprising an amorphous metal material and ii) a current carrying conductor positioned relative to said core material which, when energized creates a magnetic field for scanning the ions in the ion beam away from an initial trajectory at which they enter the magnet.

2. The ion beam implanter of claim 1 wherein the amorphous material is a amorphous metal bound in a glass substrate.

3. The ion beam implanter of claim 1 wherein scanning magnet is constructed using a core material comprising spaced laminations.

4. The ion beam implanter of claim 3 wherein the current carrying conductor that creates a magnetic field is positioned between the beam path and the core material to deflect ions passing through a region bounded by the generally planar laminations.

5. The ion beam implanter of claim 1 wherein the magnet is constructed from two magnet portions.

6. The ion beam implanter of claim 1 wherein the amorphous metal material includes metals selected from the group consisting of cobalt, iron, and nickel.

7. The ion beam implanter of claim 1 wherein the magnet core comprises multiple abutting core sections positioned along the beam path.

8. The ion beam implanter of claim 1 wherein the magnet core comprises first and second core portions that when assembled define a throughpassage for movement of ions entering the magnet and wherein the conductor extends on opposite sides of the throughpassage.

9. The ion beam implanter of claim 8 wherein a first core portion has a center segment and two side segments and a second core portion has a center segment and two side segments wherein the side segments of the first and second core portions have exposed faces that abut each other.

10. The ion beam implanter of claim 9 wherein the side segments define a magnet yoke and the center segments define magnet pole pieces that face each other across a gap which defines said throughpassage for creation of a magnetic field having a time varying magnitude for scanning ions as they move along a path through the magnet.

11. The ion beam implanter of claim 10 wherein the core portions are top and bottom core portions each made of multiple connected adjacent magnet sections positioned along a beam path.

12. The ion beam implanter of claim 11 wherein the two sections of a core portion which combine to extend across a magnet width are wound on a support and cut to form a portion of the magnet yoke and pole pieces.

13. The ion beam implanter of claim 1 additionally comprising a controller for alternating a polarity of conductor energization to produce an alternating magnetic field in the region of the magnet

14. The ion beam implanter of claim 1 wherein the electric conductor includes a passageway for routing a coolant through at least said portion of said conductor.

15. A scanning magnet for use in an ion beam implanter, the magnet having a core comprising an amorphous metal material and an electronic conductor for setting up a magnetic field for scanning the ions in the ion beam from side to side.

16. The scanning magnet of claim 15 wherein the amorphous metal material comprises metals selected from the group consisting of cobalt, iron, and nickel.

17. The scanning magnet of claim 15 wherein the magnet is constructed from two opposing magnet portions.

18. A scanning magnet for use in an ion beam implanter, the magnet having a core comprising:
an amorphous metal material comprising metals selected from the group consisting cobalt, iron and nickel having a magnetic permeability greater than 1; and
an electronic conductor for setting up a magnetic field for scanning ions in an ion beam moving in the vicinity of the scanning magnet from side to side.

19. A method of constructing a core for a magnet for use in an ion beam implanter, the core including a plurality of magnet laminations wherein the laminations are constructed from the steps comprising:
winding a flexible ribbon of an amorphous metal including a binder material about a supporting mandrel,
providing an adhesive material to join adjoining ribbon layers; and
removing the ribbon layers from the mandrel to form a core section.

20. The method of claim 19 wherein the amorphous metal material is formed from metals selected from the group consisting of cobalt, iron, and nickel.

21. The method of claim 19 wherein the binder material is a silicate material.

22. The method of claim 19 wherein the binder material is a glass material.

23. The method of claim 19 wherein the adhesive material is an epoxy.

24. The method of claim 19 comprising cutting the ribbon into portions to form abutting magnet sections.

25. The method of claim 19 wherein the mandrel is generally four sided and wherein the adjoining ribbon layers are removed from the mandrel to form two abutting U shaped magnet sections.

26. The method of claim 25 wherein multiple magnet sections are aligned along a beam path to form an ion beam throughpassage in said magnet.

27. The method of claim 26 wherein multiple loops of a conductor are aligned within the throughpassage of said magnet which, when energized create a magnetic field for deflecting ions entering the throughpassage.
